(19) United States
(12) Patent Application Publication
(10) Pub. No.: US 2004/0108730 A1
(43) Pub. Date: Jun. 10, 2004

(54) Sea pressure electricity

(76) Inventor: Frank Aloysius Walsh, Monterey, CA (US)

Correspondence Address: FRANK A. WALSH, P.O BOX 186, Santa Maria, CA, 93456, US

(21) Appl. No.: 10/213,908

(22) Filed: Dec. 9, 2002

(51) Int. Cl. H02P 9/04; F03B 13/00

(52) U.S. Cl. 290/54

(57) ABSTRACT

Sea pressure is awesome at depth. For example, at a depth of 2236 feet, the sea pressure is 1000 pounds per square inch, as compared with 14.7 psi at sea level. With the sea pressure electrical system, a hydraulic actuator is used to harness the energy of sea pressure for the production of electricity.

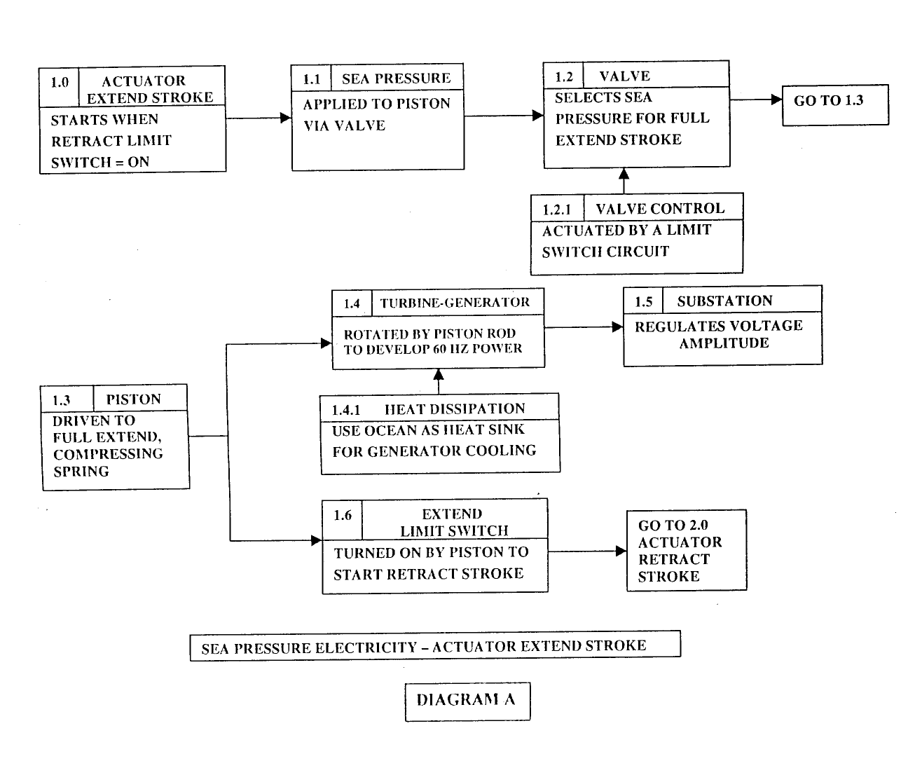

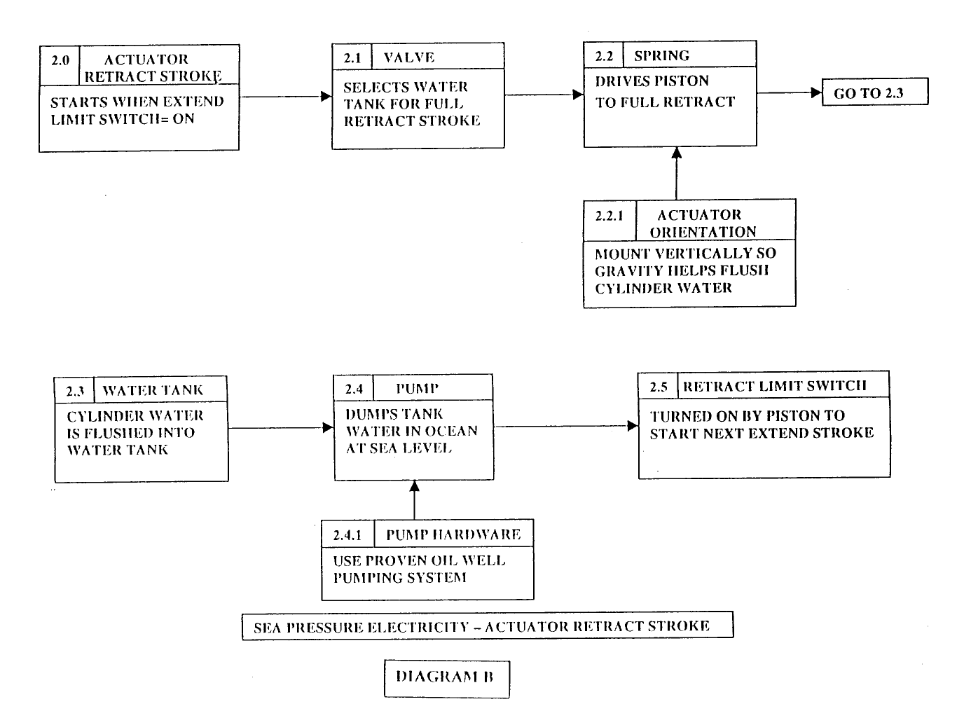

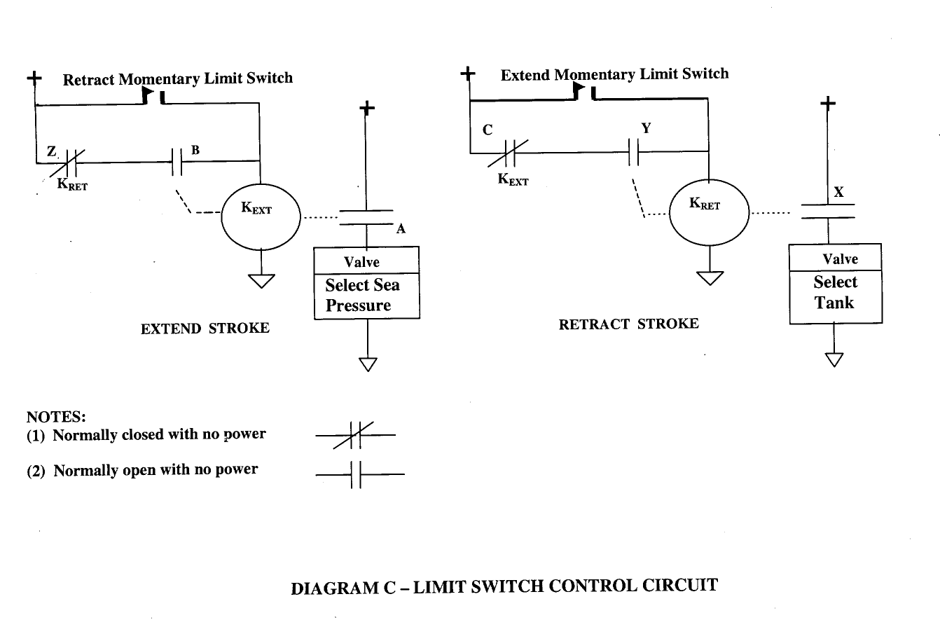

Sea pressure is transmitted through the water to an actuator piston rotating a turbine-generator while filling the actuator cylinder with water.

At full extension of the piston, a limit switch control circuit switches off sea pressure and connects the actuator cylinder to a water tank. Then, a spring drives the piston back to full retract forcing the cylinder water into the water tank. A pump dumps the tank water into the ocean at sea level. When the actuator is fully retracted, sea pressure is again applied to the piston to repeat the cycle.

So, sea pressure rotates the turbine-generator on the extend stroke to create electricity; and, spring power flushes the cylinder water into the water tank on the retract stroke. A pump then dumps the tank water into the ocean at sea level.

### INTRODUCTION

Sea pressure is awesome at depth. For example, at a depth of 2236 feet, the sea pressure is 1000 pounds per square inch, as compared with 14.7 psi at sea level. With the sea pressure electrical system, a hydraulic actuator is used to harness the energy of sea pressure for the production of electricity.

Sea pressure is transmitted through the water to an actuator piston rotating a turbine-generator while filling the actuator cylinder with water.

At full extension of the piston, a limit switch control circuit switches off sea pressure and connects the actuator cylinder to a water tank. Then, a spring drives the piston back to full retract forcing the cylinder water into the water tank. A pump dumps the tank water into the ocean at sea level. When the actuator is fully retracted, sea pressure is again applied to the piston to repeat the cycle.

So, sea pressure rotates the turbine-generator on the extend stroke to create electricity; and, spring power flushes the cylinder water into the water tank on the retract stroke. A pump then dumps the tank water into the ocean at sea level.

### FEDERALLY SPONSORED RESEARCH

Not applicable

### SEQUENCE LISTING OR PROGRAM

Not applicable

### BACKGROUND—FIELD OF INVENTION

This invention relates to the production of electricity from sea pressure for coastal cities.

### BACKGROUND—DESCRIPTION OF PRIOR ART

There is no history of sea pressure as the source energy for generating electricity.

### BACKGROUND—SEA PRESSURE HYDRAULICS

The formula for sea pressure (p) in pounds per square inch is: p=(Hd)/144 where H=depth (height) in feet; d=64.4 lbs/cu. ft.=density of seawater; 144=square ins. At a depth of 2236 feet, the pressure is 1000 psi. The formula for total force=pressure ×area. The formula for piston area is: A=(pi)r²; so, for a piston diameter of 12 inches, A=3.1416×6²=113 square inches. The total force or push applied to the piston is: 1000 psi×113 square inches, or 113,000 pounds. With two actuators pushing together, a load of 226,000 pounds can be pushed. Hydraulics has high power density.

Another useful characteristic of hydraulics is the transmission of pressure. Pressure applied to a liquid in a container is transmitted undiminished to all parts and acts in all directions (Pascal's law). Because sea pressure is omni-directional, it can drive the actuator piston upward; now gravity can flush the cylinder water into a water tank on the retract stroke.

### BACKGROUND—SYSTEM HARDWARE

SUBMARINE SHELL—is required to protect the installation from sea pressure; and, must be worker accessible. Enter the submarine through a hatchway compartment—close hatchway door, sealing off sea pressure—open inner door to submarine. A sea level atmosphere is also required.

ACTUATOR—Ruggedness in a hostile environment is a key requirement. Sensitivity and resolution are less significant. The actuator sees sea pressure on the extend stroke and spring force on the retract stroke—both are hard over commands. Mount the actuator perpendicular to the floor with the spring on top, so gravity can aid the spring on the retract stroke. The back-and-forth motion is a key requirement. A slide valve may provide this motion without a spring. By making use of the flywheel effect, it may not be necessary to power pulse the turbine on each extend stroke.

TURBINE-GENERATOR & SUBSTATION—Use hydroelectric units. The turbine rotates the generator to create a 60 hz. ac voltage. The substation adjusts the voltage magnitude.

PUMP & WATER LINE—Use a proven oil well pumping system.

SYSTEM CHECKOUT—Test system at sea level using hydraulic pressure source.

### OBJECTIVES OF THE INVENTION

The objectives of this invention are:

to harness the energy of sea pressure and, thereby, deliver electricity to coastal cities;

to strive for a system that is less complicated than the hydroelectric system;

to ensure that the system is environmentally clean.

### SUMMARY OF THE INVENTION

To satisfy the first objective of the invention, sea pressure is transmitted through seawater to an actuator piston rotating a turbine-generator while filling the cylinder with seawater. At full extension, a limit switch control circuit switches off sea pressure and connects the actuator cylinder to a water tank. Then, a spring drives the piston toward retract, forcing the cylinder water into a water tank. A pump dumps the tank water into the ocean at sea level. At full retract, sea pressure is again applied to the piston to repeat the cycle.

With respect to the 2^{nd} objective, translating river water energy into electricity requires a dam, reservoir, head, turbine and a generator. Converting sea pressure energy into electricity requires only an actuator, turbine and generator, plus a pump. So the actuator and pump replace the dam, reservoir and head, really big ticket items. The 300-mile high-tension lines (Southern California) are also eliminated for more simplicity and cost savings. Use of existing hydroelectric turbine-generator and substation reduces costs.

Considering the last objective, seawater is environmentally safe, and may be a superior cooling agent for the generator. This cooling factor could be a major advantage of the sea pressure electricity system because generator cooling is a serious problem in the hydroelectric system.

### DETAILED DESCRIPTION OF THE INVENTION

Diagrams A shows the extend stroke operation of the sea pressure electric system. During the extend stroke, the turbine-generator is rotated by the force of sea pressure. At the fully extended position, a water tank replaces sea pressure. Diagram B shows the retract stroke operation of the sea pressure electric system. During the retract stroke, the water in the actuator cylinder is flushed into a water tank; at the fully retracted position, sea pressure is again applied to the actuator piston, to initiate a new cycle. Diagram C shows the limit switch circuit. Electro-mechanical relay switching is depicted because of the ease of illustrating functional requirements. This circuit will be mechanized with solid-state logic devices including magnetic reed limit switches. Battery power will be used during startup

### DRAWINGS

Three (3) drawings are attached, namely:

DIAGRAM A, entitled “SEA PRESSURE ELECTRICITY—ACTUATOR EXTEND STROKE”, drawn by F. A. Walsh

DIAGRAM B, entitled “SEA PRESSURE ELECTRICITY—ACTUATOR RETRACT STROKE”, drawn by F. A. Walsh.

DIAGRAM C, entitled “LIMIT SWITCH CONTROL CIRCUIT”, drawn by F. A. Walsh.

1. A sea pressure electric power plant, comprising: an actuator, turbine-generator, substation/transmission line, water tank, pump and water line, limit switch control circuit and a submarine shell, wherein:
the actuator piston, driven by sea pressure, rotates the turbine generator on the extend stroke;
the piston, driven by a spring, flushes the cylinder water into a water tank on the retract stroke;
a pump and water line dumps the tank water into the ocean at sea level;
a limit switch control circuit switches the actuator to sea pressure on the extend stroke; and
switches the actuator to the water tank on the retract stroke;
the actuator, turbine-generator, substation, water tank and limit switch control circuit are installed in a submarine shell;
the submarine shell is lowered/secured to the ocean floor;
the pump is installed at sea level;
the water line is installed between the pump and the water tank;
the transmission line is installed between the substation and a relay station at sea level.
